(19) United States
(12) Patent Application Publication
(10) Pub. No.: US 2026/0159436 A1
(43) Pub. Date: Jun. 11, 2026

(54) RADIATION SHIELDING NANO-SIZED SM2O3 DOPED GLASS

(71) Applicant: GUROK HOLDING B.V., Amsterdam (NL)

(72) Inventors: Recep KURTULUS, Afyon (TR); Taner KAVAS, Afyon (TR)

(21) Appl. No.: 18/706,024

(22) PCT Filed: Dec. 14, 2022
(86) PCT No.: PCT/IB2022/062203

§ 371 Date: Apr. 30, 2024

(51) Int. Cl. C03C 4/08; C03B 1/00; C03B 25/02; C03C 1/02; C03C 3/095; G21F 1/06

(52) U.S. Cl. CPC C03C 4/087; C03C 1/026; C03C 3/095; G21F 1/06; C03B 1/00; C03B 25/02

(57) ABSTRACT

Disclosed is soda-lime-silica glass doped with radiation shielding nano-sized samarium oxide (Sm₂O₃), which provides a transparent appearance in different areas where radiation-induced ionizing rays will occur, especially in medical diagnostic centers and research institutes, and can also be used to prevent harmful radiation-induced ionizing rays.

### TECHNICAL FIELD

The invention relates to soda-lime-silica glass doped with radiation shielding nano-sized samarium oxide (Sm₂O₃), which provides a transparent appearance in different areas where radiation-induced ionizing rays will occur, especially in medical diagnostic centers and research institutes, and can also be used to prevent harmful radiation-induced ionizing rays.

### KNOWN STATE OF THE ART

As a result of the more widespread use of radiation rays due to developments in science, human beings are exposed to radiation much more. The intensity and propagation times of waves, rays and/or similar scattering with different characteristics emitted from different sources such as electronic devices are increasing day by day. Depending on the duration and dose of exposure, this situation can reach a level that threatens human health in a negative way. Especially high-energy radiations such as X-rays and/or gamma rays and/or neutrons and/or similar radiations have highly harmful effects on human health. Therefore, there is a direct risk of breaking the main bonds of biological cells. It is also likely to cause health problems in the form of DNA mutations, dry eyes and skin burns. Avoiding exposure to radiation is a vital issue when using radiation sources. For this purpose, different techniques have been developed for radiation protection.

Despite the wide use of radiation, the principle called ALARA (As-Low-As-Reasonably Achievable), which forms the basis of radiation protection, has been developed to protect against vital damages. According to this principle, radiation protection requires the lowest possible dose exposure. Reducing radiation exposure depends on the principles of low exposure time, long distance to the radiation source and armoring the source with appropriate material. The rule that aims to eliminate the effect of the dose by placing material between the radiation source and the people exposed to the dose caused by the source is called the shielding rule. The materials to be used for different types of radiation are also different. The main criteria for shielding harmful emissions from radiation are the intensity, duration and distance of the emission. For radiation shielding material design, different material types and thicknesses are used depending on the energy and intensity of the incident radiation.

Lead materials, which are often preferred among the alternative materials preferred to overcome radiation, cause serious negative consequences on both humans and the environment due to their toxic effect during their production and use. In addition, low neutron absorption capacity and lack of transparency are other shortcomings of lead and concrete-based materials. When it comes to eliminating the destructive aspects of non-ionizing emissions from radiation, high-density heavy concrete materials with different high-density heavy aggregate additions and varying thicknesses are commonly used to reduce high-energy scattering such as X-rays and/or gamma rays and/or neutrons and/or the like. However, especially during the application and use of these materials, there is a fundamental risk of changes/transformations due to phases in their structure due to time, temperature, humidity and/or similar influences, as well as risks such as crack formation and/or tearing during casting and use. At the same time, their opaque appearance makes it impossible to use them in applications where backside visibility is essential. Both metallic lead and heavy concrete materials are primary examples of known applications of the art. However, as mentioned, their use is limited due to their lack of transparency and other drawbacks. In particular, such materials cannot be used for an inspection door opening, which is a mandatory requirement of the room design criteria. Therefore, in order to overcome the aforementioned problems, different types of glass with various oxide compounds have emerged to reduce and/or eliminate the effects of high-energy scattering such as X-rays and/or gamma rays and/or neutrons and/or the like.

For this purpose, glass materials containing different ratios of lead oxide have been developed in order to reduce and/or eliminate the effects of high-energy scattering such as X-rays and/or gamma rays and/or neutrons and/or the like. The high density (9.53 g/cm³) provided by the lead oxide compound was aimed at damping or reflecting back the scattering of radiation incident on the glass material. However, even though a technically successful glass has been developed, due to the toxicity of lead oxide compound to both human health and the environment, glass materials containing lead oxide-free alternatives with the same and/or similar shielding properties have come to the forefront. In terms of alternative glass systems, although glass types such as tellerium oxide, germanium oxide, vanadium oxide-based glass have been investigated in terms of literature, they have remained incomplete as commercial products. The reasons behind this are; difficulty in accessing raw material sources, their unaffordability in terms of cost, and the fact that they are not considered reasonable within the scope of the known production methods of the art.

There are studies on radiation shielding materials in the literature.

In a study found in the art, eggshells and peanut shells were doped into soda-lime-silica glass and their radiation shielding properties were examined (B. çetin et al.)

The patent application numbered 2018/09709 is related to radiation shielding Er₂O₃-doped borosilicate glass, which can be used as window glass or exterior cladding in buildings, as well as that can also be used in the screens of devices such as computers, mobile phones and TVs that emit radiation. Here, indicators of shielding performance as a result of erbium oxide doping at varying ratios were extracted and the doping with the best performance was found.

In the patent application numbered 2018/09707, radiation shielding CeO₂ doped borosilicate glass was presented as the invention. As a result of cerium oxide doping at varying rates, indicators of shielding performance were analyzed and the doping with the best performance was found.

European patent application numbered EP1939147A1 relates to a radiation shielding glass and a method for manufacturing the same. The glass composition in question contains 10% to 35% SiO₂, 55% to 80% PbO, 0% to 10% B₂O₃, 0% to 10% Al₂O₃, 0% to 10% SrO, 0% to 10% BaO, 0% to 10% Na₂O and 0% to 10% K₂O by weight and is stated to have a total light transmittance of 50% or more at 400 nm wavelength and 10 mm thickness. However, it does not contain any information on the contribution of nano-sized samarium oxide (Sm₂O₃).

In another patent application numbered U.S. Pat. No. 10,035,725B2, a method of producing X-ray and gamma-ray shielding glass is described. The glass composition in question contains 0-35% SiO₂, 60-70% PbO, 0-8% B₂O₃, 0-10% Al₂O₃, 0-10% Na₂O, 0-10% K₂O, 0-0.3% As₂O₃, 0-2% Sb₂O₃, 0-6% BaO; and 0.05-2% ZrO₂ by weight. However, there is no content for soda-lime-silica glass doped with samarium oxide (Sm₂O₃).

As a result, due to the above-mentioned drawbacks and the inadequacy of the existing solutions, it has become necessary to develop an improvement in the relevant technical area.

### OBJECT OF THE INVENTION

The invention is inspired by the current situation and has the objective of solving the above-mentioned problems.

The primary object of the invention is to provide a specially designed lead oxide-free soda-lime-silica glass composition doped with Sm₂O₃, which protects against high-energy scattering such as X-rays and/or gamma rays and/or neutrons and/or the like, thereby minimizing the negative effects on the environment and human health caused by lead oxide-containing radiation shielding materials used in the art.

One object of the invention is to provide a newly developed transparent nano-sized Sm₂O₃-doped soda-lime-silica glass material with no harmful effects on humans and the environment.

A further object of the invention is to develop a glass material which uses readily available raw materials, is highly cost-effective and is highly adaptable to forming methods.

In order to fulfill the purposes described above, the invention is a radiation shielding lime-silica glass material that can be used to provide a transparent appearance in different areas where radiation-induced ionizing rays will occur, especially in medical diagnostic centers and research institutes, and can also be used to prevent harmful emissions from radiation, characterized by comprising SiO₂, Na₂O, CaO, MgO, Al₂O₃, Fe₂O₃ and nano-sized Sm₂O₃ dopants.

In order to fulfill the purposes described above, the invention relates to a method of manufacturing a radiation shielding soda-lime-silica glass material, characterized by comprising the following process steps:
i. preparation of the raw material composition prescription,
ii. weighing and grinding of Silica, Lime and Soda starting raw materials according to the prescription,
iii. obtained nano-sized Sm₂O₃ powder by calcination of Sm₂O₃ powder which obtained by combustion synthesis,
iv. mixing of the ground soda-lime-silica raw materials and nano-sized Sm₂O₃ powder with a mill and/or a mechanical mixer until a homogeneous mixture is formed,
v. melting the mixture in a melting furnace at a temperature between 85° and 1200° C. after obtaining a homogeneous mixture,
vi. transferring the molten glass into the forming mold and keeping it at room temperature,
vii. annealing of the final shaped glass products in an annealing furnace at temperatures between 40° and 700° C. to remove internal stresses.

The structural and characteristic features and all advantages of the invention will be more clearly understood with the following figures and the detailed description with references to these figures, and therefore the evaluation should be made by taking these figures and detailed description into consideration.

### FIGURES TO UNDERSTAND THE INVENTION

FIG. 1 is a process diagram view of the inventive radiation shielding nano-sized Sm₂O₃ doped soda-lime-silica glass.

FIG. 2 is a view of the test set-up for the subject material of the invention.

### DESCRIPTION OF PART REFERENCES

1. Raw material prescription
2. Weighing unit
3. Raw material mixer
4. Melting furnace
5. Forming mold
6. Annealing furnace
7. Glass Product
LS: Lead shielding
X: X-ray source
EXP: Glass sample
D: Detector
CS: Computer screen

### DETAILED DESCRIPTION OF THE INVENTION

In this detailed description, a radiation shielding soda-lime-silica glass material subject to the invention and the preferred embodiments of the production method are described only for a better understanding of the subject matter.

The invention does not contain lead oxide compared to various existing alternatives and thus does not pose any harm to individual health and the environment. However, it also provides superior radiation shielding capability at low energy levels compared to lead oxide-free alternatives.

The invention is a radiation shielding lime-silica glass material that allows a transparent appearance in different areas where radiation-induced ionizing rays will occur, especially in medical diagnostic centers and research institutes, and can also be used to prevent harmful radiation from radiation, and comprising SiO₂, Na₂CO₃, CaO, MgCO₃, Al₂O₃, Fe₂O₃ and nano-sized Sm₂O₃ dopants.

A preferred embodiment of the product of the present invention comprises the compounds given in Table 1 by weight percent, as well as nano-sized Sm₂O₃ dopants at 0.005 wt %, 0.05 wt % and 0.5 wt %.

TABLE 1
Chemical composition of Soda-Lime-Silica glass.

| SiO₂ | Na₂O | CaO | MgO | Al₂O₃ | Fe₂O₃ |
|---|---|---|---|---|---|
| 71.70 | 14.40 | 7.95 | 4.15 | 1.75 | 0.05 |

The linear attenuation coefficient increases with increasing Sm₂O₃ doping ratio in the inventive glass material. The highest linear attenuation coefficient is obtained with 0.5 wt % Sm₂O₃ doping.

The glass material of the invention provides a transparent appearance and the maximum glass thickness is 5 mm.

The invention relates to a method of manufacturing a radiation shielding soda-lime-silica glass material, and comprises the following process steps;
i. preparation of the raw material composition prescription,
ii. weighing and grinding of starting Silica, Lime and Soda raw materials according to the prescription,
iii. obtained nano-sized Sm₂O₃ powder by calcination of Sm₂O₃ powder that obtained by combustion synthesis,
iv. mixing of the ground soda-lime-silica raw materials and nano-sized Sm₂O₃ powder with a mill and/or a mechanical mixer until a homogeneous mixture is formed,
v. melting the mixture in a melting furnace at a temperature between 85° and 1200° C. after obtaining a homogeneous mixture,
vi. transferring the molten glass into the forming mold and keeping it at room temperature,
vii. annealing of the final shaped glass products in an annealing furnace at temperatures between 40° and 700° C. to remove internal stresses.

Our invention relates to a new radiation shielding glass for X-rays and/or gamma rays and/or fast neutrons and/or the like, comprising a nano-sized Sm₂O₃-doped soda-lime-silica (SiO₂—Na₂CO₃—CaO—MgCO₃—Al₂O₃—Al₂O₃—Fe₂O₃—Sm₂O₃) system, which may include Samarium oxide (Sm₂O₃) dopants. The radiation shielding glass comprises 15-95 mol % SiO₂, 0.01-25 mol % Na₂O, 0.01-25 mol % CaO, 0.01-15 mol % MgO, 0.01-8 mol % Al₂O₃, 0.01-30 mol % Sm₂O₃, and 0.001-1 mol % Fe₂O₃ as range values.

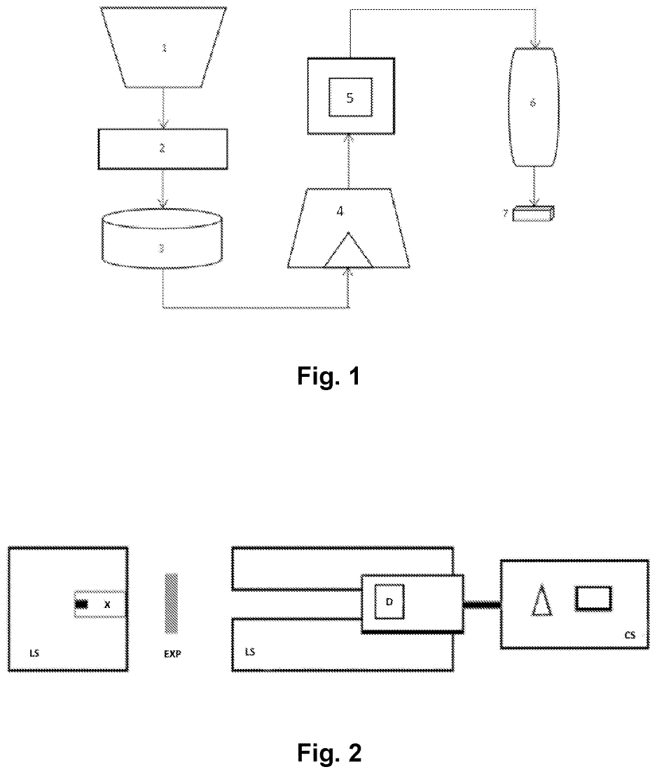

The process diagram of the inventive radiation shielding nano-sized Sm₂O₃ doped soda-lime-silica glass is given in FIG. 1.

The production method is summarized below;

In the production method of the invention, the raw material prescription is prepared by selecting soda-lime-silica starting raw materials doped with nano-sized Sm₂O₃.

First, the selected raw materials are prepared in such a way that they have a different glass composition for each different application and different prescriptions. Depending on the tolerance percentage mentioned, weighing and, if necessary, grinding is performed. Samarium (III) Nitrate Hexahydrate [Sm(NO₃)₃·6H₂O] and Glycine [H₂NCH₂COOH] which is used as fuel, react with combustion synthesis, the Sm₂O₃ powder formed after the reaction is subjected to calcination process and at the end of the process, Sm₂O₃ powders in oxide form, grain size 50-300 nm range, 99% purity are obtained. The nano-sized samarium oxide produced by the combustion synthesis method is mixed into the soda-lime-silica glass, which is ground into powder and has an average grain size below 125 μm, and then the mixing process is carried out by means of a mill and/or a mechanical mixer in a dry environment with alumina balls in a porcelain container for 15 to 60 minutes in a rotation speed range of 250 to 500 rpm in order to form a homogeneous mixture.

After obtaining the homogeneous mixture, the prepared glass batches are melted in an electric resistance elevator melting furnace and/or in a gold-platinum alloy crucible without any atmospheric control. In an electric resistance furnace, the mixtures of the samples were melted in a gold-platinum alloy crucible between 850-1200° C. and kept at a maximum temperature of 60 to 120 minutes.

As soon as the waiting time is over, the obtained glass melt is immediately poured into preferably a graphite mold or kept in a gold-platinum alloy crucible for 5 to 10 minutes at room temperature. In order to remove the internal stresses of the final shaped glass products, the glass melt is removed from the mold or gold-platinum alloy crucible and annealed in an annealing pot and/or furnace heated to 400 to 700° C. for 80 to 120 minutes. Upon completion of the waiting period, the glass product is removed from the annealing container and/or furnace and the final glass product is obtained.

The chemical compositions of the samples prepared for the product of the invention are presented in table 2 in percent by weight.

TABLE 2
Percentage weights for the prepared recipes

| Sample Codes | Soda-Lime-Silica Glass | Sm₂O₃ |
|---|---|---|
| G1 | 99.995 | 0.005 |
| G2 | 99.950 | 0.050 |
| G3 | 99.500 | 0.500 |

The radiation shielding nano-sized Sm₂O₃ doped soda-lime-silica glass samples were obtained after furnace cooling according to the above recipe.

The inventive products were subjected to tests at 40 keV energy level for the determination of linear attenuation coefficient (μ), which is fundamental among radiation shielding properties. The linear attenuation coefficient was calculated by means of the well-known Beer Lambert equation.

A drawing of the test set-up is presented in FIG. 2. It is based on the principle that radiation from an X-ray source travel through the glass sample and is picked up by a detector located behind the glass sample. In the test, the copper element was selected as the X-ray source and the measurement was performed using the HPGe DETECTOR.

The linear attenuation coefficients and mass attenuation coefficients obtained for the produced samples are given in Table 3. Based on the results obtained, it is seen from the increasing linear attenuation coefficient values that the radiation shielding property improves with increasing Sm₂O₃ doping.

TABLE 3
Linear attenuation coefficient measurement results of the samples

| Sample Codes | Linear Attenuation Coefficient (cm⁻¹) |
|---|---|
| G1 | 6.36 |
| G2 | 6.41 |
| G3 | 6.81 |

The invention makes it possible to reduce or even eliminate the effect of harmful radiation from radiation for devices operating at the relevant energy level, for example mammography. Thus, any harm to living beings in the environment is prevented. In addition, the absence of lead oxide has a positive impact on both individual health and the environment. In accordance with the regulations and legislations, there is an obligation to have a section separated by glass material in different areas where radiation-induced ionizing rays occurs, especially in medical diagnosis centers and research institutes. From this point of view, it is potential for our invention to become widespread and increase its usability.

A transparent glassware is also at risk of visually bringing out some imperfections, including scratches, bubbles or the like. To achieve a remarkable quality in glassware, it is important to remove defects. The use of an affinity improver is the main parameter that needs to be well controlled. Here, an affinity improver refers to a chemical compound that supplies clear gas to the melts to enlarge the melt bubbles to be sent away from the melt. Antimony trioxide, arsenic trioxide, sodium chloride, cerium oxide or the like are more preferably used for this purpose. In the present invention, antimony trioxide and cerium oxide can be added as affinity improvers according to quality requirements.

In our invention, density is a critical parameter which is monitored in a specific way. The higher the density of the glass system, the higher the performance of the shielding glass. The densities obtained for these glass composition variations are generally considered to be greater than 2.75-3.00 g/cm³, preferably 3.00-3.25 g/cm³, more preferably 3.25-3.50 g/cm³ and best of all greater than 3.50 g/cm³. In this study, the densities are greater than 3.25 g/cm³. As a result of uniquely designed glass systems, X-rays and/or gamma rays and/or fast neutrons and/or the like can be efficiently attenuated and/or shielded in a way that alternative shielding materials cannot achieve.

1. A radiation shielding soda-lime-silica glass that allows a transparent appearance in different areas where radiation-induced ionizing rays will occur, especially in medical diagnostic centers and research institutes, and at the same time can be used to prevent harmful emissions from radiation, the radiation shielding soda-lime-silica glass comprising SiO₂, Na₂O, CaO, MgO, Al₂O3, Fe₂O₃ and nano-sized Sm₂O₃ dopants.

2. The radiation shielding soda-lime-silica glass according to claim 1, comprising nano-sized Sm₂O₃ at 0.005% or 0.05% or 0.5% by weight.

3. The radiation shielding soda-lime-silica glass according to claim 1, by comprising 15-95 mol % SiO₂, 0.01-25 mol % Na₂O, 0.01-25 mol % CaO, 0.01-15 mol % MgO, 0.01-8 mol % Al₂O₃, 0.01-30 mol % Sm₂O₃, and 0.001-1 mol % Fe₂O₃ as range values.

4. The radiation shielding soda-lime-silica glass according to claim 1, wherein the linear attenuation coefficient increases with increasing Sm₂O₃ doping rate in the material.

5. The radiation shielding soda-lime-silica glass according to claim 1, wherein the highest linear attenuation coefficient is obtained with a 0.5 wt % Sm₂O₃ doping.

6. The radiation shielding soda-lime-silica glass according to claim 1, wherein a transparent appearance in the visible light range is provided.

7. The radiation shielding soda-lime-silica glass according to claim 1, wherein the glass thickness is maximum 5 mm.

8. A radiation shielding soda-lime-silica glass material production method comprising the following process steps:
i. preparation of a raw material composition prescription,
ii. weighing and grinding of Silica, Lime and Soda starting raw materials according to the prescription,
iii. obtaining nano-sized Sm₂O₃ powder by calcination of Sm₂O₃ powder obtained by combustion synthesis,
iv. mixing of the ground soda-lime-silica raw materials and nano-sized Sm₂O₃ powder with a mill and/or a mechanical mixer until a homogeneous mixture is formed,
v. melting the mixture in a melting furnace at a temperature between 850 and 1200° C.,
vi. transferring the molten glass into the forming mold and keeping it at room temperature,
vii. annealing of the final shaped glass products in an annealing furnace at temperatures between 40° and 700° C. to remove internal stresses.

9. The production method according to claim 8, wherein in step iii), Samarium (III) Nitrate Hexahydrate [Sm(NO₃)_{3.6}H₂O] reacts with Glycine [H₂NCH₂COOH] which is used as fuel, by combustion synthesis, calcination of the Sm₂O₃ powder formed after the reaction and at the end of the process, Sm₂O₃ powders in oxide form, with a grain size in the range of 50-300 nm, with 99% purity are obtained.

10. The production method according to claim 8, wherein in step iv), nano-sized samarium oxide obtained by combustion synthesis is doped into the soda-lime-silica raw materials, which are ground into powder and whose average grain size is below 125 μm, and a homogeneous mixture is obtained with a mechanical mixer.

11. The production method according to claim 8, wherein the mixing process as mentioned in process step iv) is carried out at a rotational speed range of 250 to 500 rpm and for a duration of 15 to 60 minutes.
